(19) United States
(12) Patent Application Publication
(10) Pub. No.: US 2011/0004613 A1
(43) Pub. Date: Jan. 6, 2011

(54) METHOD, APPARATUS AND COMPUTER PROGRAM PRODUCT FOR HANDLING INTELLIGENT MEDIA FILES

(75) Inventors: Juha Arrasvuori, Tampere (FI); Jouka Mattila, Tampere (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 12/496,561

(22) Filed: Jul. 1, 2009

(51) Int. Cl. G06F 17/30

(52) U.S. Cl. 707/769; 707/803; 707/783; 707/E17.009; 707/E17.014; 707/E17.005

(57) ABSTRACT

A method, apparatus and computer program product are disclosed which provide availability to a media file with the media file including media data and access to associated instructions regarding the disposition of the media file in response to one or more inputs. The method, apparatus and computer program product may also receive information as an input and then automatically alter at least one aspect of the media file. The at least one aspect of the media file may be automatically altered based upon the input and as directed by the instructions associated with the media file that define the disposition of the media file.

### TECHNICAL FIELD

Embodiments of the present invention relate generally to media files, and, more particularly, to automated techniques for handling media files.

### BACKGROUND

With the proliferation of computer technology and the convergence of computing devices, media files, such as files containing still images, video images, audio recordings and/or the like, have greatly expanded in number. In this regard, some users store a large number of media files upon their computing devices to permit the users to readily access the media files and to share the media files with others, thereby further increasing the population of media files. Moreover, the media file collection of many users is dynamic with additional media files being frequently added to the collection of media files stored on the computing device. For example, additional media files may be received from friends, co-workers or the like and/or additional media files may be newly created, such as by capturing images, recording video images, audio signals or the like.

The architecture of a typical media file includes media data and metadata. The metadata is data describing, for example, the content and technical information of the media data. The media data has a variety of properties including, for example, physical size, tint, brightness, contrast, and direction of movement for still and video images, and amplitude, frequency range and direction of movement for audio signals. The properties of the media data may be modified with an external application, although the process by which such modifications may be made may not always be intuitive for a user and may therefore not be employed by all users.

### BRIEF SUMMARY

A method, apparatus and computer program product are provided in accordance with example embodiments of the present invention for providing improved handling of media files. In this regard, a method, apparatus and computer program product of example embodiments of the present invention may provide for the properties of the media files to be more readily and intuitively modified and, in some instances, to be modified in an automated manner. Further, a method, apparatus and computer program product of example embodiments of the present invention may facilitate file management including storage, association and retrieval of the media files that may be less time consuming for a user and, in one embodiment, may be performed in an automated manner.

In one example embodiment, a method is disclosed which receives information as an input to a media file. The media file may include media data and access to associated instructions regarding the disposition of the media file in response to one or more inputs. The method of this example embodiment also automatically alters at least one aspect of the media file. In this embodiment, the at least one aspect of the media file is automatically altered in accordance with the input and as directed by the instructions associated with the media file that define the disposition of the media file.

In one embodiment, the information that is received relates to context such that the automatic alteration of at least one aspect to the media file includes the automatic alteration of one or more properties of the media data based upon the context. For example, the information relating to context may be information defining whether the media data is to be output privately or publicly. In this example, the automatic alteration of one or more properties of the media data may include the automatic alteration of the content of the media data based upon whether the media data is to be output privately or publicly.

In another embodiment, the information that is received may include information that is output from another media file. In this embodiment, the automatic alteration of at least one aspect of the media file may include the automatic alteration of one or more properties of the media data based upon the output from the other media file. In another embodiment, the input that is received may include information from a database such that the automatic alteration of at least one aspect of the media file may include the automatic alteration of at least one aspect of the media file based upon an association defined by the instructions between the information from the database and at least one of the media data and the metadata associated therewith.

The instructions of one example embodiment at least partially define a preferred behavior for the media file. In this regard, the automatic alteration of at least one aspect of the media file may include the automatic alteration of the storage location of the media file based upon the preferred behavior. In another embodiment, the automatic alteration of at least one aspect of the media file may include the automatic association that the media file with a geo-location based upon the input. In a further embodiment, a query may be issued and the input may be received in response to the query.

An apparatus and a computer program product may also be provided in accordance with other example embodiments of the present invention. In this regard, an apparatus may be provided in accordance with an embodiment to the present invention which includes at least one processor and at least one memory including computer program code. The at least one memory and the computer program code are configured to, with the at least one processor, cause the apparatus to receive information as an input to a media file with the media file including media data and access to associated instructions regarding disposition of the media file in response to one or more inputs. The at least one memory and the computer program code of this example embodiment are also configured to, with the at least one processor, cause the apparatus to automatically alter at least one aspect of the media file based upon the input and as directed by the instructions associated with the media file that define the disposition of the media file. Further, the computer program product of an example embodiment includes at least one computer readable storage medium having computer-executable program code portions stored therein. The computer executable program code portions of this embodiment include program code computer instructions for receiving information as an input to a media file with the media file including media data and access to associated instructions regarding disposition of the media data in response to one or more inputs. The computer executable program code portions of this embodiment also include program code instructions for automatically altering the media file based upon the input and as directed by the instructions associated with the media file that define the disposition of the media file.

### BRIEF DESCRIPTION OF THE DRAWING(S)

Having thus described embodiments of the invention in general terms, reference will now be made to the accompanying drawings, which are not necessarily drawn to scale, and wherein:

FIG. 1 is a block diagram of a media file in accordance with an example embodiment of the present invention;

FIG. 2 is a block diagram of an apparatus in accordance with an example embodiment of the present invention;

FIG. 3 is a flowchart illustrating operations performed in accordance with an example embodiment of the present invention;

FIG. 4 is a representation of a manner in which the properties of a first media file are provided to a second media file in accordance with an example embodiment of the present invention;

FIG. 5 is a representation of a manner in which media files may be associated to each other and/or reorganized in accordance with an example embodiment of the present invention;

FIG. 6 is another representation of a manner in which the properties a first media file may be provided to a second media file in accordance with another example embodiment of the present invention; and

FIG. 7 is a representation of a manner in which media files may be associated with a geo-location in accordance with an example embodiment of the present invention.

### DETAILED DESCRIPTION

Example embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout. The terms “data,” “content,” “information,” and similar terms may be used interchangeably, according to some example embodiments of the present invention, to refer to data capable of being transmitted, received, operated on, and/or stored. Moreover, the term “exemplary”, as used herein, is not provided to convey any qualitative assessment, but instead merely to convey an illustration of an example. Thus, use of any such terms should not be taken to limit the spirit and scope of the embodiments of the present invention.

As used herein, the term ‘circuitry’ refers to all of the following: (a) hardware-only circuit implementations (such as implementations in only analog and/or digital circuitry); (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

For media files stored on a computing device, each media file is stored at a particular location in, for example, the file system. Typically, the location of a media file in the file system is monitored by an operating system of the computing device. With the proliferation of media files, however, some users may find it difficult or at least time consuming to manage the media files, particularly as new media files are frequently added to their collection. In this regard, organizing and optimizing media files within a file system, in such a manner as to facilitate the subsequent location of a media file and its association with other similar or related files, may be a tedious and/or a time consuming task for users. As such, it may be desirable to provide improved techniques for managing and/or processing media files. For example, automatic techniques, for modifying the properties and/or the storage location of a media file, improve a user's experience.

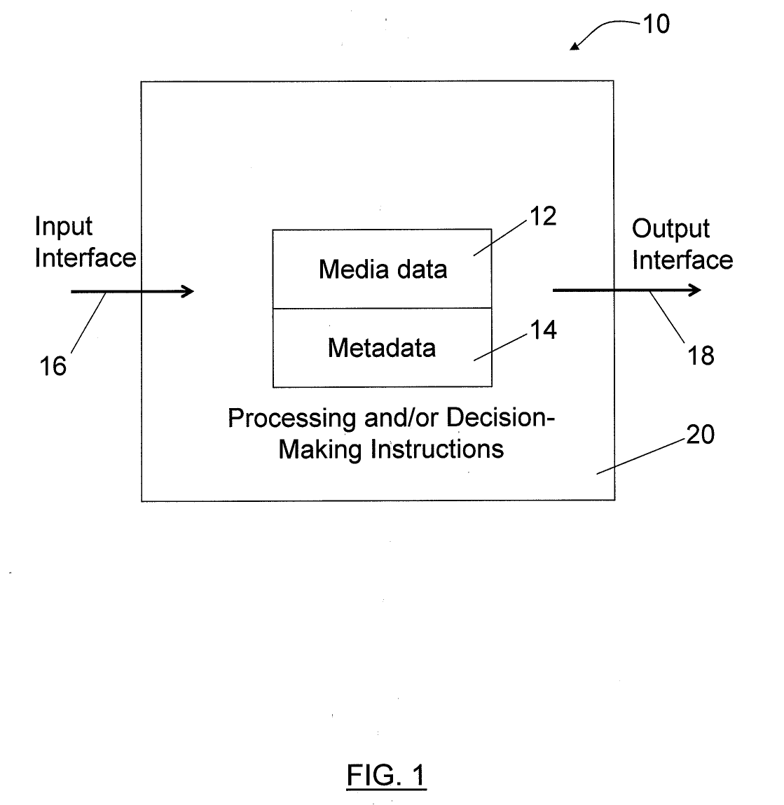

FIG. 1 depicts a media file 10 in accordance with an example embodiment of the present invention. The media file includes media data 12 and associated metadata 14. The media file may include various types of media data, such as audio date, image data, text, animation content, graphics content, a combination of two or more of these types of media data, and/or the like. Regardless of the type of media data, the metadata is data regarding the media data and/or properties of the media data. By way of example, the metadata includes keyword descriptions of the media data, description of events associated with media date, time information, location information, information about media data creation/creator, the privacy level setting of the media data and/or the like.

The media file 10 of the example embodiment also includes an input interface 16 and an output interface 18. The input interface 16 allows the media file to receive information, for example, from another media file, from an application, from an operating system, from a device user, from a sensor, from a device or device component and/or the like. The output interface allows the media file to send information, for example, to another media file, to an application, to an operating system, to a device or device component, to a sensor and/or the like. The input interface 16 and the output interface 18 of a media file are implemented, for example, as computer instructions, as an application associated with the media file, as application programming interface(s) (API) and/or the like. According to an example embodiment, a media file receives various types of inputs and may provide various types of outputs. Several examples of the inputs and outputs are provided below. In one embodiment, however, inputs and outputs are provided for each of the properties of the associated media data with the properties capable of changing from one type of media file to another. For example, in instances in which the media data is a still or video image, inputs and outputs may be provided to define the physical size, tint, brightness and/or contrast of the still or video image with video images also including a transfer property indicating a direction of movement. Alternatively, if the media data is audio data, inputs and outputs may be provided for the amplitude and/or frequency range of the audio data, along with direction of movement for stereo audio data. Additionally, inputs and outputs may be provided with respect to the metadata, such as inputs and outputs for identifying keywords for including within the metadata.

The media file 10 of the illustrated embodiment also includes processing and/or decision-making instructions 20. The processing and/or decision-making instructions 20 define various types of processing functions and/or decision-making abilities associated with the media file. For example, the instructions may include instructions to modify one or more properties of a media file such as permitting still or video images to be cropped, providing equalization and/or filtering of audio files, changing the playback speed of audio or video files, or changing the hue of a still or video image. With respect to the decision-making abilities, the instructions may permit a user to define a preferred behavior for the media file and to then direct the playback or storage of the media file in such a way as to achieve or approximate the preferred behavior.

The media file 10 may be stored in a memory of a device and the instructions 20 of the media file may be executed by a processor or the like in order to appropriately process the media file and/or to make appropriate decisions regarding the media file. In an example embodiment, the instructions of the media file are stored along with the media data and the metadata such that a resulting media file is self-contained. Alternatively, the media file may include an interface, such as an application programming interface (API), to facilitate access to the instructions stored external to the media file, such as within another media file or otherwise stored at a location external to the media file. For example, the API of a media file interacts with a client application that provides the instructions for processing and/or decision-making regarding the media file. In this regard, the operating system of the device in which the media file resides may provide a plurality of client applications that are accessible via the API of a media file with each client application being associated with a different type of media content, such as audio, video or the like. In another example, the API of a media file provides access to other types of applications or an external plug-in, such as an application employed to handle media files, an image browser having a map interface, a photo editing tool, a video editing tools, and/or the like. External plug-ins include, for example, a plug-ins for Virtual Studio Technology (VST) effects for audio files or Photoshop® plug-ins for image or video files. Applications and/or plug-ins accessed by the API provide the instructions for the media file in order to appropriately process and/or make decisions regarding the media file. Regardless of the location of the instructions and the manner in which the instructions are accessed, the media file according to at least one example embodiment of the present invention provides access to the instructions that define the manner in which the media file is to be handled in response to one or more inputs, thereby including meaningful intelligence regarding the handling of the media files within the media file itself.

The media file 10 may be stored and processed by a plurality of different types of apparatuses. An apparatus that stores the media file may be embodied as, or included as a component of a communications device with wired or wireless communications capabilities. In some example embodiments, the apparatus may be part of a communications device, such as a stationary terminal, such as a desktop computer or a server, or a mobile terminal. For example, as a mobile terminal, the apparatus may be a mobile computer, mobile telephone such as a cell phone, a portable digital assistant (PDA), a pager, a mobile television, a gaming device, a storage device, a mobile computer, a laptop computer, a camera, a video recorder, an audio/video player, a radio, and/or a global positioning system (GPS) device, any combination of the aforementioned, or the like. Regardless of the type of communications device, apparatus may also include computing capabilities.

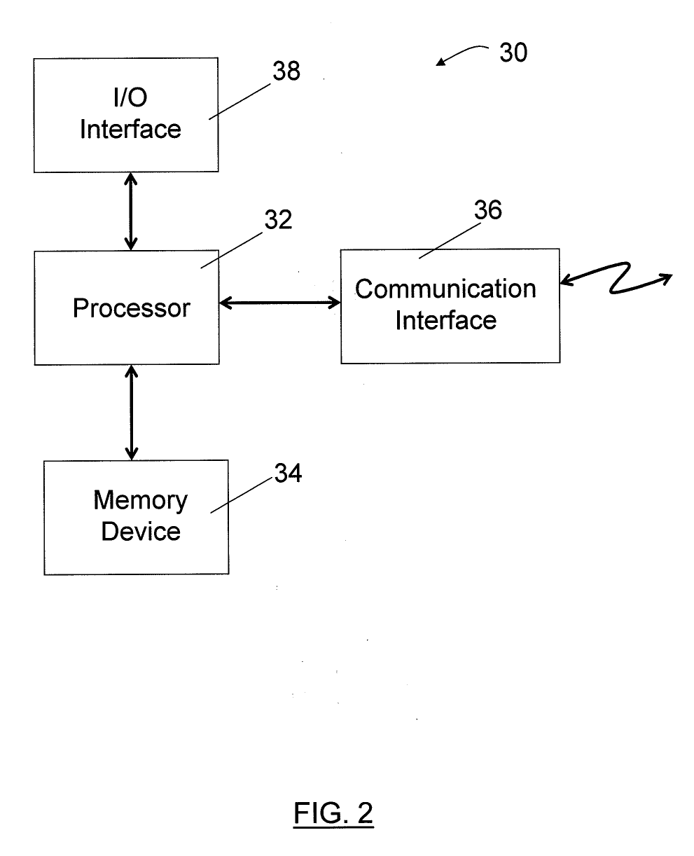

FIG. 2 is a block diagram of an apparatus 30 in accordance with an example embodiment of the present invention. The apparatus 30 includes or is otherwise in communication with a processor 32, a memory device 34, a communications interface 36 and an Input/Output (I/O) interface 38. The processor may be embodied as various means for implementing the various functionalities of example embodiments of the present invention including, for example, a microprocessor, a coprocessor, a controller, a special-purpose integrated circuit such as, for example, an ASIC (application specific integrated circuit), an FPGA (field programmable gate array), or a hardware accelerator, processing circuitry or the like. According to one example embodiment, processor may be representative of a plurality of processors, or one or more multiple core processors, operating in concert. Further, the processor may be comprised of a plurality of transistors, logic gates, a clock (e.g., oscillator), other circuitry, and the like to facilitate performance of the functionality described herein. The processor may, but need not, include one or more accompanying digital signal processors. In some example embodiments, the processor 32 is configured to execute instructions stored in the memory device or instructions otherwise accessible to the processor, such as the instructions 20 included within or accessible via the media files 10 and/or the instructions that define the input interface 16 and the output interface 18. The processor may be configured to operate such that the processor causes the apparatus to perform various functionalities described herein.

Whether configured as hardware or via instructions stored on a computer-readable storage medium, or by a combination thereof, the processor 32 may be an entity capable of performing operations according to embodiments of the present invention while configured accordingly. Thus, in example embodiments where the processor is embodied as, or is part of, an ASIC, FPGA, or the like, the processor is specifically configured hardware for conducting the operations described herein. Alternatively, in example embodiments where the processor is embodied as an executor of instructions stored on a computer-readable storage medium, the instructions specifically configure the processor to perform the algorithms and operations described herein. In some example embodiments, the processor is a processor of a specific device (e.g., a mobile terminal) configured for employing example embodiments of the present invention by further configuration of the processor via executed instructions for performing the algorithms, methods, and operations described herein.

The memory device 34 may be one or more computer-readable storage media that may include volatile and/or non-volatile memory. In some example embodiments, the memory device includes Random Access Memory (RAM) including dynamic and/or static RAM, on-chip or off-chip cache memory, and/or the like. Further, memory device may include non-volatile memory, which may be embedded and/or removable, and may include, for example, read-only memory, flash memory, magnetic storage devices (e.g., hard disks, floppy disk drives, magnetic tape, etc.), optical disc drives and/or media, non-volatile random access memory (NVRAM), and/or the like. Memory device may include a cache area for temporary storage of data. In this regard, some or all of memory device may be included within the processor 32.

Further, the memory device 34 may be configured to store information, data, applications, computer-readable program code instructions, and/or the like for enabling the processor 32 and the example apparatus 30 to carry out various functions in accordance with example embodiments of the present invention described herein. For example, the memory device may be configured to buffer input data for processing by the processor. Additionally, or alternatively, the memory device may be configured to store instructions for execution by the processor. In one example embodiment, the memory device is configured to store the media files 10 and, as such, may include a file system within which the media files are organized and stored.

The I/O interface 38 may be any device, circuitry, or means embodied in hardware, software, or a combination of hardware and software that is configured to interface the processor 32 with other circuitry or devices, such as the communications interface 36. In some example embodiments, the processor may interface with the memory 34 via the I/O interface 38. The I/O interface 38 may be configured to convert signals and data into a form that may be interpreted by the processor. The I/O interface 38 may also perform buffering of inputs and outputs to support the operation of the processor. According to some example embodiments, the processor and the I/O interface 38 may be combined onto a single chip or integrated circuit configured to perform, or cause the apparatus 30 to perform, various functionalities of the present invention.

The communication interface 36 may be any device or means embodied in either hardware, a computer program product, or a combination of hardware and a computer program product that is configured to receive and/or transmit data from/to a network and/or any other device or module in communication with the example apparatus 30. Processor 32 may also be configured to facilitate communications via the communications interface by, for example, controlling hardware included within the communications interface. In this regard, the communication interface may include, for example, one or more antennas, a transmitter, a receiver, a transceiver and/or supporting hardware, including, for example, a processor for enabling communications. Via the communication interface 36, the example apparatus may communicate with various other network entities in a device-to-device fashion and/or via indirect communications via a base station, access point, server, gateway, router, or the like.

The communications interface 36 may also include power control logic for powering down unneeded radios, modem components, and the like, when the apparatus 30 enters a sleep or idle mode. In this regard, the processor 32 may be configured to control the power control logic to initiate an activate mode to support data transfers, and return to a sleep mode when data transfers are complete.

The communications interface 36 may be configured to provide for communications in accordance with any wired or wireless communication standard. The communications interface may be configured to support communications in multiple antenna environments, such as multiple input multiple output (MIMO) environments. Further, the communications interface may be configured to support orthogonal frequency division multiplexed (OFDM) signaling. In some example embodiments, the communications interface may be configured to communicate in accordance with various techniques, such as, second-generation (2G) wireless communication protocols, IS-136 (time division multiple access (TDMA)), GSM (global system for mobile communication), IS-95 (code division multiple access (CDMA)), third-generation (3G) wireless communication protocols, such as Universal Mobile Telecommunications System (UMTS), CDMA2000, wideband CDMA (WCDMA) and time division-synchronous CDMA (TD-SCDMA), 3.9 generation (3.9G) wireless communication protocols, such as Evolved Universal Terrestrial Radio Access Network (E-UTRAN), with fourth-generation (4G) wireless communication protocols, international mobile telecommunications advanced (IMT-Advanced) protocols, Long Term Evolution (LTE) protocols including LTE-advanced, or the like. Further, communications interface 36 may be configured to provide for communications in accordance with techniques such as, for example, radio frequency (RF), infrared (IrDA) or any of a number of different wireless networking techniques, including WLAN techniques such as IEEE 802.11 (e.g., 802.11a, 802.11b, 802.11g, 802.11n, etc.), wireless local area network (WLAN) protocols, world interoperability for microwave access (WiMAX) techniques such as IEEE 802.16, and/or wireless Personal Area Network (WPAN) techniques such as IEEE 802.15, BlueTooth (BT), low power versions of BT, ultra wideband (UWB), Wibree, Zigbee and/or the like. The communications interface 36 may also be configured to support communications at the network layer, possibly via Internet Protocol (IP).

In operation and as described above, the apparatus 30, such as the processor 32 in conjunction with the memory device 34, provides availability to a media file 10, such as shown in FIG. 1, which includes media data and access to associated instructions that relate to the disposition of the media file in response to one or more inputs. For example, the media files may be stored in the memory device, which is accessible by and available to the processor. The instructions generally define the manner in which the media file is to be handled in response to one or more inputs. Thus, the media file of one example embodiment contains or provides access to the instructions that define the manner in which the media file will respond to certain inputs, thereby effectively creating an intelligent media file.

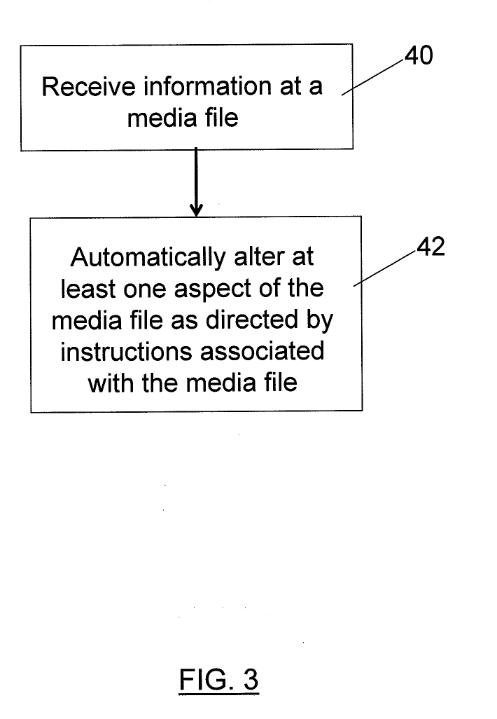

As shown in operation 40 of the flowchart of FIG. 3, the apparatus 30 may then receive information as an input to the media file 10. For example, the apparatus of FIG. 2 may receive information via the communications interface 36 that, in turn, is provided to the media file via the input interface 16. The apparatus, such as a processor, may then automatically alter at least one aspect of a media file, such as a property of the media file, the manner in which the media file is presented, the storage location of the media file and/or the like. See operation 42 of FIG. 3. In this regard, the processor may automatically alter at least one aspect of a media file in accordance with the disposition of the media file defined by the instructions and based upon the information that has been received via the input interface. For example, the processor may execute those instructions that are associated with the information that has been received with the instructions thereafter causing the processor to automatically alter at least one aspect of the media file.

As referenced above, FIG. 3 is a flowchart of a method, and/or according to an example embodiment of the invention. It will be understood that each block or operation of the flowchart, and/or combinations of blocks or operations in the flowcharts, is implementable by various means. Means for implementing the blocks or operations of the flowchart, combinations of the blocks or operations in the flowchart, or other functionality of example embodiments of the present invention described herein may include hardware, and/or a computer program product including a computer-readable storage medium having one or more computer program code instructions, program instructions, or executable computer-readable program code instructions stored therein. In this regard, program code instructions, such as the instructions 20 included within or accessible via a media file 10, may be stored on a memory device, such as memory devices 34, of an example apparatus, such as example apparatus 30, and executed by a processor, such as the processor 32. As will be appreciated, any such program code instructions may be loaded onto a computer or other programmable apparatus from a computer-readable storage medium to produce a particular machine, such that the particular machine becomes a means for implementing the functions specified in the flowcharts' block(s) or operation(s). These program code instructions may also be stored in a computer-readable storage medium that may direct a computer, a processor, or other programmable apparatus to function in a particular manner to thereby generate a particular machine or particular article of manufacture. The instructions stored in the computer-readable storage medium may produce an article of manufacture, where the article of manufacture becomes a means for implementing the functions specified in the flowcharts' block(s) or operation(s). The program code instructions may be retrieved from a computer-readable storage medium and loaded into a computer, processor, or other programmable apparatus to configure the computer, processor, or other programmable apparatus to execute operations to be performed on or by the computer, processor, or other programmable apparatus. Retrieval, loading, and execution of the program code instructions may be performed sequentially such that one instruction is retrieved, loaded, and executed at a time. In some example embodiments, retrieval, loading and/or execution may be performed in parallel such that multiple instructions are retrieved, loaded, and/or executed together. Execution of the program code instructions may produce a computer-implemented process such that the instructions executed by the computer, processor, or other programmable apparatus provide operations for implementing the functions specified in the flowcharts' block(s) or operation(s).

Accordingly, execution of instructions associated with the blocks or operations of the flowchart by a processor, or storage of instructions associated with the blocks or operations of the flowcharts in a computer-readable storage medium, support combinations of operations for performing the specified functions. It will also be understood that one or more blocks or operations of the flowcharts, and combinations of blocks or operations in the flowcharts, may be implemented by special purpose hardware-based computer systems and/or processors which perform the specified functions, or combinations of special purpose hardware and program code instructions.

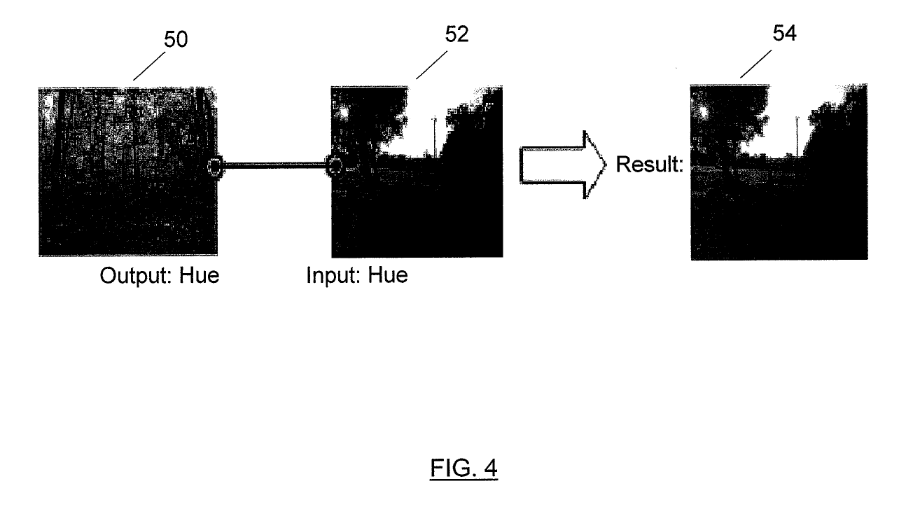

The media file 10 may receive various types of information via the input interface 16 and provide various types of outputs via the output interface 18. As noted above, for example, a plurality of inputs and outputs may be provided with each input and/or output associated with a different property of the media file. As such, an input may be provided to define the respective property of the media file. Although the input defining a respective property of a media file may be provided in various manners, the input to one media file may be provided by the output of another media file such that the respective property of the recipient media file, e.g., the media file receiving the input, may be altered in such a fashion as to be the same or otherwise consistent with that same property of the source media file, e.g., the media file providing the output. As shown in FIG. 4, for example, the output of a source media file 50 that defines the hue of the source image file may be connected to the input interface of a recipient media file 52 that also defines the hue of the recipient media file. In response to the input relating to the hue, the processor 32 may adjust the hue of the media data of the recipient media file to be consistent with that of the first media file. For example, the source media file may be a photo of a forest in which the dominant color, e.g., hue, is green, while the recipient media file may be a black and white photograph. By connecting the hue output of the source media file to the hue input of the recipient media file, the processor may execute the instructions of the source media file that relate to the disposition of the second media file in response to a hue input in order to produce a resulting image 54 that has a green tint. In this regard, it is noted that the black and white images of FIG. 4 may not fully convey the change in tint, but the resulting image 54 of this embodiment has a green tint as depicted in FIG. 4 by the softening or lightening of at least some portions that were darker in the black and white photograph of the recipient media file 52 as a result of the hue of the source image file 50.

The input interfaces 16 and output interfaces 18 of media files 10 may be connected in various manners. For example, a representation of the different media files may be presented by the processor upon a user interface, such as a display. Upon selection of a media file (or an icon representative of the media file), a listing of the various input and output parameters may be provided. Thereafter, a user may interconnect the output of a source media file to the input of a recipient media file, such as by drawing a line or otherwise providing an indication that the inputs and outputs are to be connected. Additionally, while the foregoing discussion regarding FIG. 4 describes the interconnection of two media files, three or more media files may be similarly interconnected with the output of one media file serving as an input to another media file so as to thereby define an interconnected and interdependent chain of media files. Furthermore, while a single input and a single output have been utilized in the example of FIG. 4, multiple inputs and/or multiple outputs may be concurrently provided if so desired.

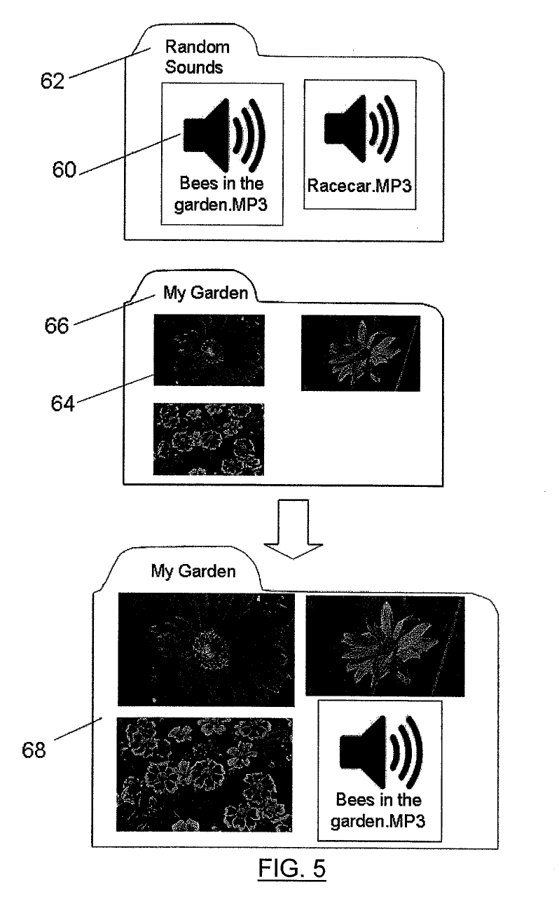

While the embodiment of FIG. 4 provides for the automatic alteration of a property of the media data, other aspects of the media file may, instead, be automatically altered, such as the storage location of the media file. In addition, the input that is received and then utilized in the automatic alteration of an aspect of the media file need not necessarily relate to a property of the media file, but may be a wide variety of other data, information or the like, such as may be provided by a common sense database or the like. As another example, FIG. 5 depicts a situation in which an apparatus 30, such as the memory device 34, includes a file system having a plurality of folders for storing media files. As shown, one folder 62 is configured to store audio files of random sounds and another folder 66 entitled My Garden is configured to store media files, such as still image files, relating to the garden. In this embodiment, the memory device of the apparatus also stores a database that defines a number of relationships or associations. In one embodiment, this database may be a common sense database or may otherwise employ a common sense algorithm. By way of example, the database may include a listing of a number of objects that are all associated with one another. For example, bees and flowers may be defined to have an association by the database. In relation to the example depicted in FIG. 5, the audio file in the Random Sounds folder entitled Bees in the garden 60 may include metadata that includes the key word bee, while the image files 64 in the My Garden folder may include metadata that includes the keyword flower. Based upon the input provided by the database, such as the listing of keywords that are associated or otherwise have a relationship with one another, the processor 32, in the course of executing the instructions 16 of the media file 10, may be directed to determine any associations (as defined by the database) between the keywords of the various media files such that the processor recognizes that the audio file entitled Bees in the garden is associated with the image files in the My Garden folder. The processor may then relocate the audio file entitled Bees in the garden to the My Garden folder 68, thereby automatically altering an aspect of the media file, namely, its location within the file system. As such, the processor may automatically reorganize the media files in accordance with predefined associations or relationships, thereby facilitating the subsequent access and use of the media files by the user.

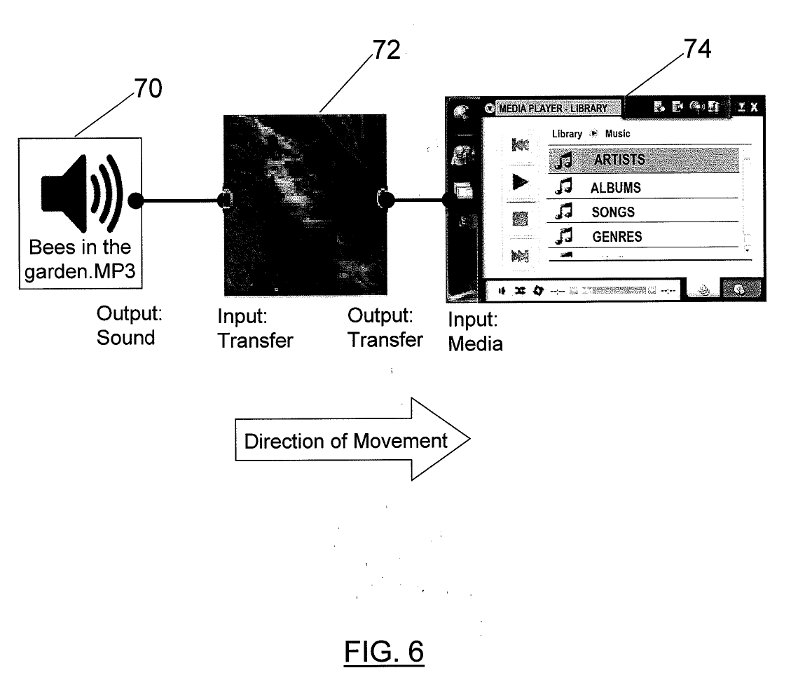

In another embodiment, a source media file may be transferred through another media file in such a manner so that one or more properties of the source media file are changed to be the same as or to more closely approximate the respective properties of the other media file. In other word, one or more properties of the other media file are transferred to the source media file. In another example depicted in FIG. 6, the output sound of the audio file 70 entitled Bees in the garden may be connected, such as in the manner described above, to the transfer input of a video file 72 of a flowing river. By connecting the transfer output of the video file to a media player application 74, such as executed by the processor 32 of the apparatus 30, the output of the audio file is altered so that the properties of the audio file are the same as or more closely approximate the properties of the video file. In this regard, one property of the video file relates to a direction of movement, such as the flow of the river from left to right in the illustrated example. As such, the audio recording of a bee that is otherwise mono, may be panned by the media player application in the same direction as defined by the transferred property of the video image, that is, from left to right.

The properties that are to be transferred to the source file may be identified in various manners. For example, a user may select one or more properties from a menu, such as a pull-down menu that is activated by placement of a cursor or other pointer on an icon representative of the media file. The properties that are available for selection may be defined by the system implementers and the apparatus 30 may check to determine if a particular property is available for a respective media file. As opposed to relying upon user selection, the apparatus, such as the processor 32, may detect that a certain type of media file, such as a video file, has been chosen to provide an input to another certain type of media file, such as an audio file. In this example embodiment, the apparatus, such as the processor, may select a predefined property that is to be transferred to the source file. For example, the predefined property may be the most common property to transfer between the different types of media files, such as the panning movement that is most commonly transferred from a video file to an audio file.

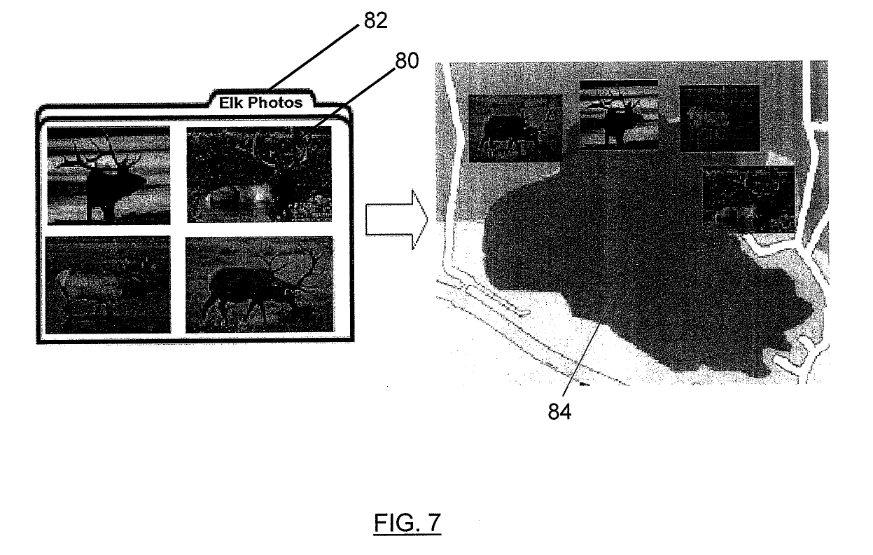

As noted above, the automatic alteration of at least one aspect of a media file may include the alteration of the storage location of the media file. In a comparable effort to automatically provide improved organization and accessibility of the media files, the method of other embodiments of the present invention may also provide for the automatic association of media files with a geo-location. By way of example, a file folder 82 may include a plurality of image files 80, such as photos of elks from around the world as shown in FIG. 7. Although the user may not invest the time to organize the photos, the processor 32 may be directed by the instructions of the media files 10 to access a database, such as a common sense database, that may provide information regarding the behavior of an elk including, for example, information that elk generally live near a lake with sweet water and other information identifying known sweet water lakes. In response to this information provided by the database, the processor, in response to execution of the instructions of the media file, may be directed to identify the nearest sweet water lake, such as by accessing a map service that may provide information regarding the location of various lakes. Based upon the information regarding the location of various lakes and the current location of the user, such as may be determined by a Global Positioning System (GPS) unit of the apparatus 30, the processor may determine the lake that is nearest to the user. Once the processor has determined the location of the nearest lake having sweet water, the processor may then obtain an image or map 84 of the lake and may then associate the image files with the map or image of the lake, such as shown in FIG. 7 in order to provide intuitive context for the image files and to facilitate subsequent access and use of the image files by the user.

In addition to assisting in the organization of the media files, the properties of the location may also utilized by the processor 32 in response to execution of the instructions 20 of the media file 10 to alter the media file. In this regard, the properties of a location may be determined, for example, from a topographical map or a satellite image of the location. By way of example and with reference to the photographs of the elk near a lake, the instructions of the media file may direct the processor to receive the blue color property of the lakes as an input and to increase or introduce a blue tint to the photographs and/or to emphasize the features of the photographs that are blue, such as the sky.

The information that is provided via the input interface 16 to the media file 10 may also relate to the context, such as the current environment of the apparatus 30. In this regard, the context may be provided to the apparatus or may be determined by the apparatus. In either instance, at least one aspect of the media file may be automatically altered based upon the context. By way of example, the apparatus may control the manner in which the media file is presented in accordance with a determination as to whether the context is public or private and as defined by the instructions 20 of the media file. In this regard, a media file may be processed to have one appearance that is intended for private consumption and another appearance that is suitable for public consumption with the more confidential or explicit portions of the private version having been removed from the public version. For example, an image file may include the wife and two children of the user. As such, the private appearance of the photo would include the wife and the two children. However, the user may not wish to publically provide images of his two children such that the public appearance of the image may include only his wife with the children having been cropped out. Continuing with this example, the apparatus may be a mobile terminal, such as a mobile phone having two displays positioned on opposite sides of the mobile terminal. The display on the back side of the apparatus may be considered public in that it is visible to everyone, while the display on the front side of the apparatus may be considered private as it is visible only to the user. As such, in instances in which the user moves the image file to the back side display, the instructions associated with the image file may direct the processor to recognize that the backside display is public and to direct the back side display to display the public appearance of the image showing only the user's wife. However, when the user moves the image file from the back side display to the front side display, the instructions of the media file may again direct the processor to recognize that the front side display is private and to accordingly display the private appearance of the photograph including the user's wife and two children.

By way of another example in which the automatic alteration of an aspect of a media file is based upon context, an audio file may include one version having explicit lyrics and another version in which the explicit lyrics have been muted. In instances in which the output of the audio file is being provided to headphones and is therefore private, the instructions associated with the image file may direct the processor 32 to cause the explicit version of the audio file to be presented. Alternatively, in instances in which the processor detects that the audio file is to be outputted via speakers and is therefore public, the instructions associated with the image file may direct the processor to present the censored version in which the explicit lyrics have been muted.

As with the database that defines associations and relationships between various media files, a user can define a preferred behavior for media files or at least certain type's of media files. The preferred behavior may also be stored by the memory device 34 and may be accessed by the processor 32 in response to instructions 20 of a media file 10. The instructions may then direct the media file to handle the media file in such a manner that the media file and the properties thereof are modified so as to match the preferred behavior or to otherwise as closely approximate the preferred behavior as possible. For example, a user may indicate that all image files that include the keyword family in the metadata are to be stored in a family folder, while other image files relating to other topics are to be stored in another folder.

Additionally, while the information is provided via the input interface 16 to an otherwise passive media file 10 in the foregoing embodiments, the media file may be configured to more actively solicit an input, such as from another media file. For example, the instructions 20 of the media file may direct the processor 32 to issue a specific query with the response to the query thereafter serving as the input to the media file in order to at least partially direct a subsequent automatic alteration of at least one aspect of the media file in accordance with the response. In this regard, one exemplary query may be “Where am I” with responses ranging from the geo-location of the apparatus 30, to a specific file within the file hierarchy of the file system to a physical device, such as a particular display of a multi-screen device. Based upon any one or more of these responses, the instructions may direct the processor to correspondingly alter at least one aspect of the media file in an automated fashion.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims. Although specific terms are employed herein, they are used in a generic and descriptive sense only and not for purposes of limitation.

1. A method comprising:
receiving information as an input to a media file, wherein the media file comprises media data and access to associated instructions regarding disposition of the media file in response to one or more inputs; and
automatically altering at least one aspect of the media file, by a processor, based at least in part on the input and as directed by the instructions associated with the media file that define the disposition of the media file.

2. A method according to claim 1 wherein receiving information as an input comprises receiving information relating to context, and wherein automatically altering at least one aspect of the media file comprises automatically altering one or more properties of the media data based at least in part on the context.

3. A method according to claim 2 wherein receiving information relating to context comprises receiving information defining whether the media data is to be output privately or publicly, and wherein automatically altering one or more properties of the media data comprises automatically altering content of the media data based at least in part on whether the media data is to be output privately or publicly.

4. A method according to claim 1 wherein receiving information as an input comprises receiving information that is output from another media file, and wherein automatically altering at least one aspect of the media file comprises automatically altering one or more properties of the media data based at least in part on the received information from said another media file.

5. A method according to claim 1 wherein the instructions at least partially define a preferred behavior for the media file.

6. A method according to claim 5 wherein automatically altering at least one aspect of the media file comprises automatically altering a storage location of the media file based at least in part on the preferred behavior.

7. A method according to claim 1 wherein receiving information as an input comprises receiving information from a database, and wherein automatically altering at least one aspect of the media file comprises automatically altering at least one aspect of the media file based at least in part on an association defined by the instructions between the information from the database and at least one of the media data and metadata associated therewith.

8. A method according to claim 1 wherein automatically altering at least one aspect of the media file comprises automatically associating the media file with a geo-location based at least in part on the input.

9. A method according to claim 1 further comprising issuing a query and then receiving information as the input in response to the query.

10. An apparatus comprising at least one processor and at least one memory including computer program code, the at least one memory and the computer program code configured to, with the at least one processor, cause the apparatus to at least perform:
receiving information as an input to a media file, wherein the media file comprises media data and access to associated instructions regarding disposition of the media file in response to one or more inputs; and
automatically altering at least one aspect of the media file based at least in part on the input and as directed by the instructions associated with the media file that define the disposition of the media file.

11. An apparatus according to claim 10 wherein receiving information as an input comprises receiving information relating to context, and wherein automatically altering at least one aspect of the media file comprises automatically altering one or more properties of the media data based at least in part on the context.

12. An apparatus according to claim 11 wherein receiving information relating to context comprises receiving information defining whether the media data is to be output privately or publicly, and wherein automatically altering one or more properties of the media data comprises automatically altering content of the media data based at least in part on whether the media data is to be output privately or publicly.

13. An apparatus according to claim 10 wherein receiving information as an input comprises receiving information that is output from another media file, and wherein automatically altering at least one aspect of the media file comprises automatically altering one or more properties of the media data based at least in part on the received information from said another media file.

14. An apparatus according to claim 10 wherein the instructions at least partially define a preferred behavior for the media file.

15. An apparatus according to claim 14 wherein automatically altering at least one aspect of the media file comprises automatically altering a storage location of the media file based at least in part on the preferred behavior.

16. An apparatus according to claim 10 wherein receiving information as an input comprises receiving information from a database, and wherein automatically altering at least one aspect of the media file comprises automatically altering at least one aspect of the media file based at least in part on an association defined by the instructions between the information from the database and at least one of the media data and metadata associated therewith.

17. An apparatus according to claim 10 wherein the apparatus comprises at least one of a mobile terminal, a cell phone, a laptop computer, a desktop computer, a server and a storage device.

18. A computer program product comprising at least one computer-readable storage medium having computer-executable program code portions stored therein, the computer-executable program code portions comprising:
program code instructions for receiving information as an input to a media file, wherein the media file comprises media data and access to associated instructions regarding disposition of the media file in response to one or more inputs; and
program code instructions for automatically altering at least one aspect of the media file based at least in part on the input and as directed by the instructions associated with the media file that define the disposition of the media file.

19. A computer program product according to claim 18 wherein the program code instructions for facilitating receipt of information as an input comprise program code instructions for facilitating receipt of information relating to context, and wherein the program code instructions for automatically altering the media file comprise program code instructions for automatically altering one or more properties of the media data based at least in part on the context.

20. A computer program product according to claim 18 wherein the program code instructions for facilitating receipt of information as an input comprise program code instructions for facilitating receipt of information that is output from another media file, and wherein the program code instructions for automatically altering the media data comprise program code instructions for automatically altering one or more properties of the media data based at least in part on the received information from said another media file.
